(19) United States
(12) Patent Application Publication
(10) Pub. No.: US 2006/0118727 A1
(43) Pub. Date: Jun. 8, 2006

(54) Radiation detector and radiographic imaging system

(76) Inventor: Hisanori Tsuchino, Tokyo (JP)

Correspondence Address: CANTOR COLBURN, LLP, 55 GRIFFIN ROAD SOUTH, BLOOMFIELD, CT, 06002, US

(21) Appl. No.: 11/236,954

(22) Filed: Sep. 28, 2005

(30) Foreign Application Priority Data
Sep. 29, 2004 (JP) 2004-283710

(51) Int. Cl. G01T 1/20

(52) U.S. Cl. 250/361 R

(57) ABSTRACT

A radiation detector for identifying the kind of the scintillator from the outward appearance of the detector, includes: a scintillator for generating fluorescence by receiving radiation; and a detector indication section for indicating scintillator information relating to the scintillator.

### BACKGROUND OF THE INVENTION

1. Field of the Invention

The present invention relates to a radiation detector and a radiographic imaging system which is utilized at the time of radiographic imaging of a subject.

2. Description of the Related Art

In the field of radiographic imaging for medical diagnosis, there has been widely known a radiographic imaging system in which a subject is irradiated with radiation and an intensity distribution of the radiation transmitted through the subject is detected to obtain a radiographic image of the subject. In a recent radiographic imaging system, there has been developed and used a radiation detector called a “flat panel detector”, which is formed into a thin flat plate having a large number of photoelectric conversion elements arranged thereon in a matrix. This radiation detector photoelectrically converts the radiation transmitted through the subject into electric signals, and performs image processing on the converted electric signals, thereby obtaining easily and rapidly the radiographic image of the subject.

The radiation detector is broadly classified into a “direct conversion type” detector that converts the radiation directly into electric signals, and an “indirect conversion type” detector that converts the radiation into fluorescence and then converts the fluorescence into electric signals. The indirect conversion type radiation detector generally has a scintillator arranged therein, the scintillator receiving the radiation to emit fluorescence with intensity according to the quantity of received radiation (refer, for example, to JP 7-140255A). In case of using this type of radiation detectors, radiographic imaging conditions have to be chosen according to the kinds of scintillators, because sensitivity for radiation differs from each other among the kinds of scintillators.

However, in conventional indirect conversion type radiation detectors, including the radiation detector disclosed in JP 7-140255, it is difficult to identify the kind of scintillator from its appearance, so that it is possible to start radiographic imaging mistaking other radiation detector for a target detector at wrong sight. In this case, radiographic imaging would not be performed under the most suitable condition for the kind of scintillator, resulting in lowered quality of the radiographic image finally obtained.

### SUMMARY OF THE INVENTION

An object of the invention is to provide a radiation detector and a radiographic imaging system capable of identifying the kind of scintillator from the appearance.

In a first aspect of the invention, a radiation detector comprises:

a scintillator for generating fluorescence by receiving radiation; and

a detector indication section for indicating scintillator information relating to the scintillator.

According to the first aspect of the invention, the detector comprises the detector indication section for indicating scintillator information, so that the kind of scintillator can be easily identified from the outward appearance of the detector. Accordingly, without mistaking other radiation detector at wrong sight for the target radiation detector, it can be possibly prevented that radiographic imaging might be carried out without considering the kind of scintillator.

Preferably, in the first aspect of the invention, the radiation detector further comprises:

a detector main body comprising the scintillator; and

a cassette for accommodating the detector main body,

wherein the cassette comprises the detector indication section on at least a portion of an outer surface thereof.

Preferably, in this case, the detector main body comprises the detector indication section.

Preferably, in the first aspect of the invention, the detector further comprises:

a detector memory section for storing the scintillator information; and

a detector controller for causing at least a part of the scintillator information stored in the detector memory section, to be displayed on the detector indication section.

In a second aspect of the invention, a radiographic imaging system comprises: a radiation detector comprising a scintillator for generating fluorescence by receiving radiation, and a console for controlling an operation of the radiation detector,

wherein the radiation detector comprises:

a detector communication section for communicating with the console; and

a detector indication section for indicating scintillator information relating to the scintillator.

According to the second aspect of the invention, the radiation detector comprises the detector indication section for indicating scintillator information, so that the kind of scintillator can be easily identified from the outward appearance of the detector. Accordingly, without mistaking other radiation detector at wrong sight for the target radiation detector, it can be possibly prevented that radiographic imaging might be carried out without considering the kind of scintillator.

Preferably, in the second aspect of the invention, the console comprises a console display section for displaying at least a part of the scintillator information.

Preferably, in the second aspect of the invention, the radiation detector further comprises:

a detector memory section for storing the scintillator information; and

a detector controller for causing at least a part of the scintillator information stored in the detector memory section, to be displayed on the detector indication section.

Preferably, in this case, the console comprises:

a console communication section for communicating with the radiation detector; and

a console display section for displaying at least a part of the scintillator information, and

wherein the detector controller causes the console display section to display at least a part of the scintillator information stored in the detector memory section through the detector communication section and the console communication section.

Preferably, in the second aspect of the invention, the imaging system comprises a plurality of the radiation detectors.

In a third aspect of the invention, a radiographic imaging system comprises a radiation detector comprising a scintillator for generating fluorescence by receiving radiation, and a console for controlling an operation of the radiation detector,

wherein the radiation detector comprises:

a detector communication section for communicating with the console; and

a detector indication section for indicating scintillator information relating to the scintillator, and

wherein the console comprises:

a console communication section for communicating with the radiation detector;

a console memory section for storing the scintillator information;

a console display section for displaying at least a part of the scintillator information; and

a console controller for causing the detector indication section to display at least a part of the scintillator information stored in the console memory section through the detector communication section and the console communication section.

According to the third aspect of the invention, the detector indication section displays at least a part of the scintillator information, so that the kind of scintillator can be easily identified from the outward appearance of the detector. Accordingly, without mistaking other radiation detector at wrong sight for the target radiation detector, it can be possibly prevented that radiographic imaging might be carried out without considering the kind of scintillator.

Preferably, in the third aspect of the invention, the imaging system comprises a plurality of the radiation detectors.

### BRIEF DESCRIPTION OF THE DRAWINGS

The present invention will become more fully understood from the detailed description given below and the accompanying drawings which are given by way of illustration only, and thus are not intended to limit the scope of the invention, and wherein:

FIG. 1 is a view showing a schematic configuration of a radiographic imaging system;

FIG. 2 is a perspective view showing a schematic configuration of a radiation detector;

FIG. 3 is a block diagram showing a circuit configuration of the radiographic imaging system;

FIG. 4 shows one example of a first data table;

FIG. 5 shows one example of a second data table;

FIG. 6 is a diagram showing a schematic configuration of a radiographic imaging system according to a second embodiment;

FIG. 7 is a diagram showing a schematic configuration of a radiographic imaging system according to a third embodiment; and

FIG. 8 is a block diagram showing a circuit configuration of the radiographic imaging system according to the third embodiment.

### DETAILED DESCRIPTION OF THE PREFERRED EMBODIMENTS

Preferred embodiments of the invention will be described below with reference to the accompanying drawings, and the scope of the invention is not limited to the exemplified drawings.

### First Embodiment

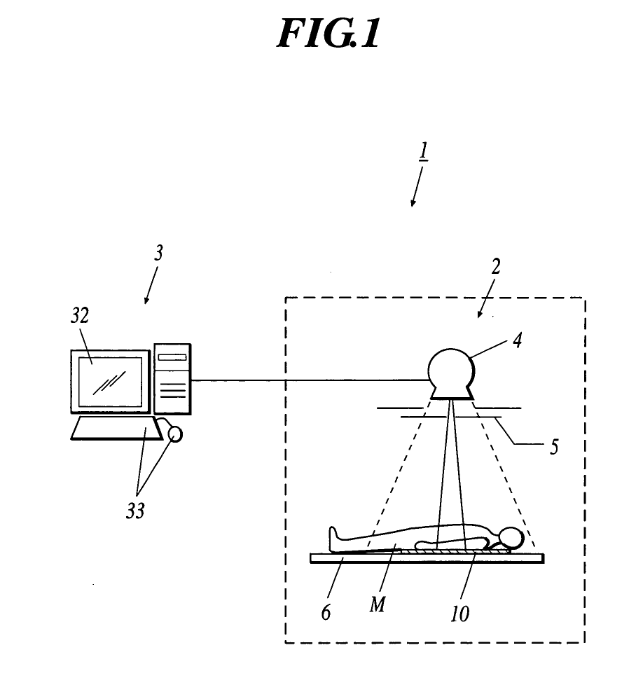

FIG. 1 is a view showing a schematic configuration of a radiographic imaging system 1.

As shown in FIG. 1, the radiographic imaging system 1 includes an imaging apparatus 2 for radiographing a subject M, and a console 3 for irradiating the subject M with radiation to generate a radiographic image of the subject M. The imaging apparatus 2 is installed and used at a medical institution such as a medical office and/or a hospital. The imaging apparatus 2 includes a radiation source 4 that generates radiation with a tube voltage applied thereto. At a radiation opening of the radiation source 4, there is provided a diaphragm 5 for adjusting an irradiating field of the radiation by opening/closing an aperture. Under the radiation source 4, there is provided a bed 6 on which the subject M is laid within an irradiating area of the radiation. On the bed 6, a radiation detector 10 is arranged for detecting the amount of radiation transmitted through the subject M. The radiation detector 10 is a portable cassette type radiation detector removably arranged on the bed 6.

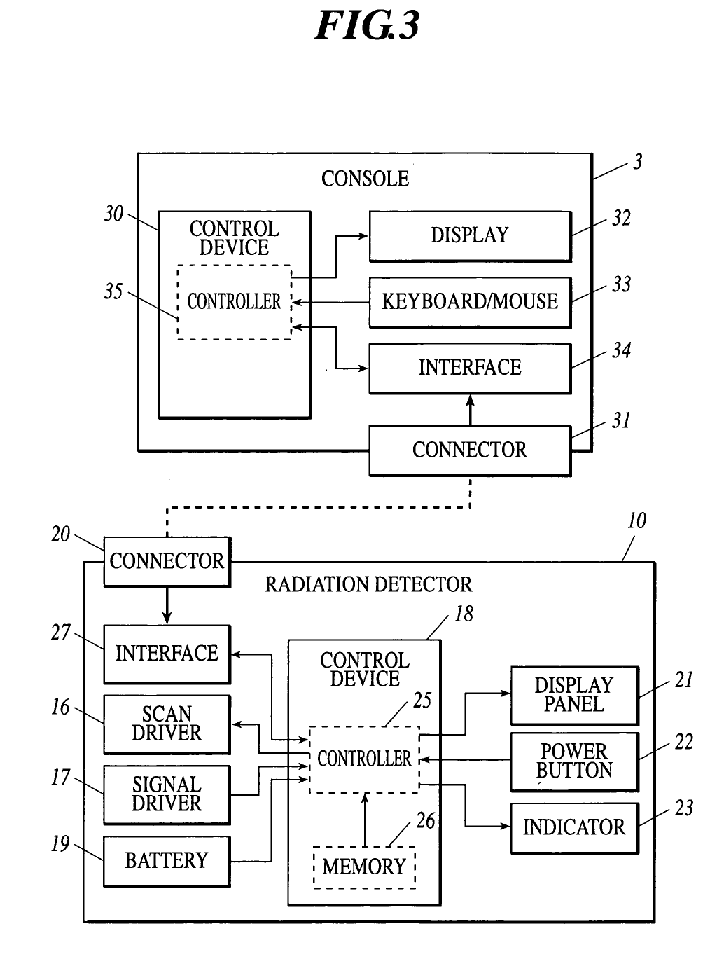

The console 3 is a general purpose computer, and includes a control device 30 (see FIG. 3) for generating a radiographic image of the subject M based on the detected result by the radiation detector 10. The console 3 further includes a connector 31 (see FIG. 3) for communicating with the imaging apparatus 2 and the radiation detector 10, a display 32 for displaying the radiographic image of the subject M and the like, and keyboard/mouse 33 for inputting to the control device 30 imaging information relating to the subject M and the radiation detector 10.

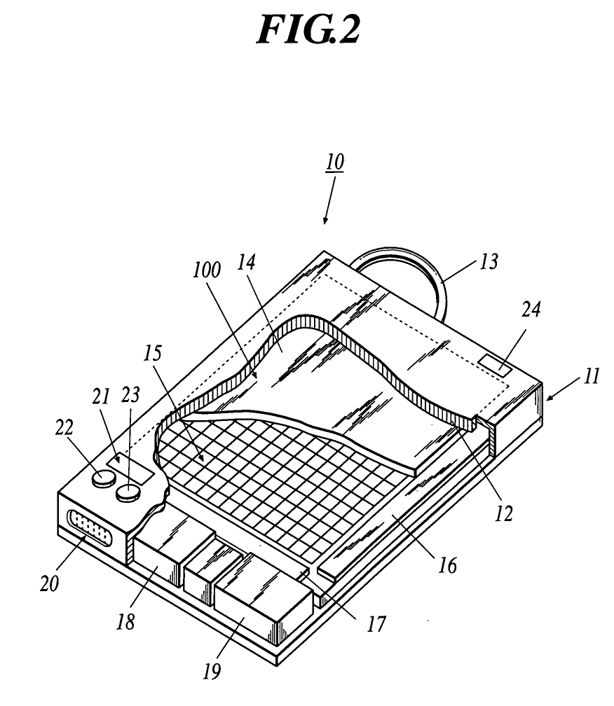

FIG. 2 is a perspective view showing a schematic configuration of the radiation detector 10 according to the invention.

As shown in FIG. 2, the radiation detector 10 has a thin parallelepiped cassette 11, and a grid 12 as a part of a top plate of the cassette 11 for absorbing and eliminating scattered components of the radiation. On one side of the cassette 11, there is arranged a grip 13 so that the radiation detector 10 can be easily carried.

The cassette 11 accommodates a detector main body 100 for receiving the radiation transmitted through the subject M and substantially detecting the quantity of the radiation. The detector main body 100 has a rectangular scintillator 14 which receives the radiation to emit fluorescence with intensity corresponding to the intensity of the radiation. The scintillator 14 contains phosphor, such as CsI:Tl and GOS (Gd₂O₂S: Tb). Under or below the scintillator 14, there is arranged a flat-plated fluorescent detection panel 15 for detecting the fluorescence.

The fluorescent detection panel 15 has a large number of photoelectric conversion elements arranged thereon in a matrix (grid shape), the element receiving the fluorescence and storing electric energy according to the quantity of receiving light. At side portions of the fluorescent detection panel 15, there are arranged a scan driver 16 to scan and drive the respective photoelectric conversion elements by sending pulses to the respective photoelectric conversion elements, and a signal driver 17 to read the electric energy stored in the respective photoelectric conversion elements.

In the detector main body 100, there are arranged a control device 18 for controlling operations of the scan driver 16, the signal driver 17 and other parts, and a battery 19 as a power supply source. The battery 19 is removably mounted on the detector main body 100 and the cassette 11, and can be easily replaced with other battery 19 at the time of charging operation.

On the detector main body 100, there are further arranged a connector 20 for communicating with the console 3, a display panel 21 consisting of a liquid crystal panel or the like capable of displaying characters, symbols and the like, a power button 22 for turning on/off the power of the radiation detector 10, and an indicator 23 consisting of LEDs (light emitting diodes) that can be lit in a plurality of different colors from each other.

Here, at a corner on an outer surface of the cassette 11, there is affixed a label 24. Written on the label 24 is items relating to the scintillator 14 with characters, symbols and the like, and thus the label 24 functions as a detector indicating part for indicating information on the kind of the scintillator 14 (hereinafter referred to as “scintillator information”). The scintillator information includes mainly substance, form and thickness of the scintillator 14, and may further include sensitivity, use and the like of the scintillator 14.

For example, in case that the scintillator 14 consists of phosphor of “substance is CsI:Tl, formed in columnar crystal, with a thickness of 600 μm”, there is written on the label 24 with characters like “CsI:Tl, columnar crystal, 600 μm”. On the other hand, in case that the scintillator 14 consists of phosphor of “substance is GOS(Gd₂O₂S: Tb), formed in a coated layer, with a thickness of 2 mm”, there is written on the label 24 with characters like “GOS, coated layer, 2 mm”.

With such a structure, the cassette 11 has an identification function according to the information on the scintillator 14, and the label 24 (or its corresponding indication) functions as the detector indication part to realize the identification function.

FIG. 3 is a block diagram showing a circuit configuration of the radiographic imaging system 1.

As shown in FIG. 3, in the radiation detector 10, a control device 18 has a controller 25 as a detector controller. The controller 25 includes a general purpose CPU (central processing unit), ROM (read only memory) and RAM (random access memory). The CPU uses the RAM as a work area, and executes various processing according to processing programs stored in the ROM.

The controller 25 includes parts connected thereto, such as interface 27, scan driver 16, signal driver 17, display panel 21, power button 22, indicator 23, and controls these parts according to operating states of respective parts.

The interface 27 is a detector communication part to send and receive signals to and from an external device connected to the connector 20, and the controller 25 can communicate with the external device, such as the console 3, through the interface 27.

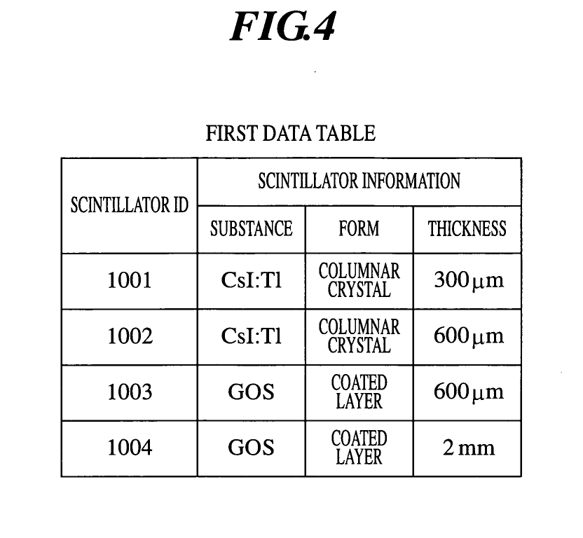

The control device 18 further includes a memory 26 as a detector memory part consisting of a HDD (hard disk drive) or the ROM. The memory 26 stores in advance a first data table as shown in FIG. 4. In the first data table, scintillator IDs (identifications) and the scintillator information correspond to each other so that a kind of scintillator can be identified from a scintillator ID. The scintillator ID is a unique ID that differs from each other according to the kinds of scintillators, and stored in the memory 26 in advance. That is, the memory 26 of the control device 18 stores in advance the first data table and the scintillator IDs corresponding to the kinds of scintillators.

In the embodiment, the controller 25 reads out from the memory 26 a scintillator ID and the first data table, identifies the scintillator information in the first data table based on the scintillator ID, and displays the identified scintillator information on the display panel 21 as well as lights the indicator 23 in a color corresponding to the identified scintillator information. That is, each of the display panel 21 and the indicator 23 is also a detector indication part for displaying the scintillator information, thus has the same function as of the label 24 described above.

For example, when the controller 25 recognizes the scintillator ID with “1002”, as shown in FIG. 4, the controller 25 identifies from the first data table the contents “substance is CsI:Tl, formed in columnar crystal, with a thickness of 600 μm” as the scintillator information, and displays the identified contents on the display panel 21 as well as selects a color to be lit (blue or the like) corresponding to the identified contents to light the indicator 23 in the color.

Similarly, when the controller 25 recognizes the scintillator ID with “1004”, as shown in FIG. 4, the controller 25 identifies from the first data table the contents “substance is GOS, formed in a coated layer, with a thickness of 2 mm” as the scintillator information, and displays the identified contents on the display panel 21 as well as selects a color to be lit (pink or the like) corresponding to the identified contents to light the indicator 23 in the selected color.

On the other hand, in the console 3, a control device 30 has a controller 35 as a console controller. The controller 35 includes a general purpose CPU (central processing unit), ROM (read only memory) and RAM (random access memory). The CPU uses the RAM as a work area, and executes various processing according to the processing programs stored in the ROM.

The controller 35 includes parts connected thereto, such as a display 32, keyboard/mouse 33, an interface 34, and the like, and controls each part according to operating states of these parts. The interface 34 is a console communication part to send and receive signals to and from an external device connected to the connector 31, and the controller 35 can communicate with the external device, such as the radiation detector 10, through the interface 34.

In the radiographic imaging system 1, the connector 20 in the radiation detector 10 and the connector 31 in the console 3 are connected to each other by a member such as a cable, so that the detector 10 can communicate with the console 3 through the interface 27 and the interface 34. Similarly, the console 3 and the imaging apparatus 2 can communicate with each other.

Communication between the radiation detector 10 and the console 3, or between the imaging apparatus 2 and the console 3, is implemented by wired communication as described above, but may be implemented by known wireless communication, or by known wired or wireless communication through a network. Particularly, when a communication network is applied, it is preferable to use, for example, a wireless LAN (local area network) for realizing connection from the imaging apparatus 2, the console 3 and the detector 10 to the network.

Next, the operation and action of the radiographic imaging system 1 will be described.

In a situation that the imaging apparatus 2 and the console 3 or the radiation detector 10 and the console 3 can communicate with each other, a radiologist or an operator watches the label 24 on the radiation detector 10, selects a radiation detector 10 including the desired scintillator 14, and installs the detector 10 on the bed 6.

When the operator turns on the detector 10 by pressing the power button 22 with the detector 10 installed on the bed 6 (or before installation), the controller 25 in the control device 18 reads out from the memory 26 a scintillator ID and the first data table, identifies the scintillator information in the data table based on the scintillator ID, and sends a control signal corresponding to the scintillator information to the display panel 21 and the indicator 23. Receiving this signal, the display panel 21 displays the scintillator information in characters or the like, and the indicator 23 is also lit with a color corresponding to the scintillator information.

In this situation, the operator chooses most suitable condition corresponding to the kind and characteristics of the selected and installed scintillator 14 with input operation of keyboard/mouse 33 of the console 3, and enables the imaging apparatus 2 to start radiographic imaging of the subject M under this condition, then the following operation starts.

That is, the imaging apparatus 2 irradiates the subject M laid on the bed 6 with radiation emitted from the radiation source 4 through the diaphragm 5, and the radiation transmitted through the subject M is incident on the radiation detector 10. When the radiation is incident on the radiation detector 10, the radiation, scattered component of which is absorbed and eliminated by the grid 12 of the detector 10, is incident on the scintillator 14, and the scintillator 14 emits fluorescence with intensity according to the intensity of the radiation.

When the scintillator 14 emits fluorescence, respective photoelectric conversion elements in the fluorescent detection panel 15 receive fluorescence emitted from the scintillator 14, and store electric energy according to the received quantity of light. After the photoelectric conversion elements store electric energy, the control device 18 controls the scan driver 16 and the signal driver 17 so that the scan driver 16 sends pulses to respective photoelectric conversion elements and the signal driver 17 reads out the electric energy stored in respective photoelectric conversion elements.

When the signal driver 17 reads out the electric energy, the signal driver 17 converts the electric energy into electric signals, and outputs the electric signals to the control device 18 as “image information” of the subject M, then the control device 18 sends the image information to the console 3. When the console 3 receives the image information, the control device 30 executes image processing on the received image information to generate a radiographic image, and displays the radiographic image on the display 32 as the radiographic image of the subject M.

In the radiographic imaging system 1, the cassette 11 has the label 24 affixed thereon, the label 24 having the scintillator information written thereon, so that the operator can easily identify the kind of the scintillator 14 within the cassette 11 from the outward appearance of the detector 10. Further, on the detector main body 100, the display panel 21 displays the scintillator information, and the indicator 23 is lit with a color corresponding to the contents of the scintillator information, so that the operator can surely identify the kind of the scintillator 14 inside the cassette 11 from the outward appearance of the radiation detector 10.

Accordingly, such a situation can be possibly prevented that radiographic imaging of the subject M might be carried out under a condition not considering the kind of the scintillator 14, without mistaking other radiation detector 10 at wrong sight for the target radiation detector 10, (the other detector 10 having a different kind of scintillator 14 from that of the target detector 10).

The present invention is not limited to the above-described first embodiment, and various variations and modifications may be made without departing from the scope of the invention.

As a first modification, at least one information item may be written on the label 24 out of the scintillator information items, such as substance, form, thickness, sensitivity, use, etc. That is, any one of the items, any two to four items, or five and more items may be written on the label 24.

As another modification, the label 24 may have respective colors according to the scintillator information. For example, if the scintillator 14 consists of phosphor of “substance is CsI:Tl, formed in columnar crystal, with a thickness of 600 μm”, the label may be colored with “blue”, and if the scintillator 14 consists of phosphor of “substance is GOS, formed in a coated layer, with a thickness of 2 mm”, the label 24 may be colored with “pink”, and so forth.

As another modification, the label 24 is affixed to the cassette 11 in the embodiment, but the scintillator information may be written directly on the cassette 11, or the cassette itself may be colored partially or entirely with a color corresponding to the scintillator information. After all, the scintillator information may be indicated on the cassette 11 so that substance, form, thickness, sensitivity, use, and the like of the scintillator 14 accommodated inside the cassette 11 can be identified from the appearance of the cassette 11. Further, the indication is not limited to one position, and may be applied to two and more positions.

Alternatively, the indication corresponding to the label 24 may also be arranged at one and more positions on the detector main body 100 (not shown). In this case, the detector main body 100 also has an identification function cooresponding to the scintillator information, thus the kind of scintillator 14 can be identified not only from the cassette 11 but also from the detector main body 100.

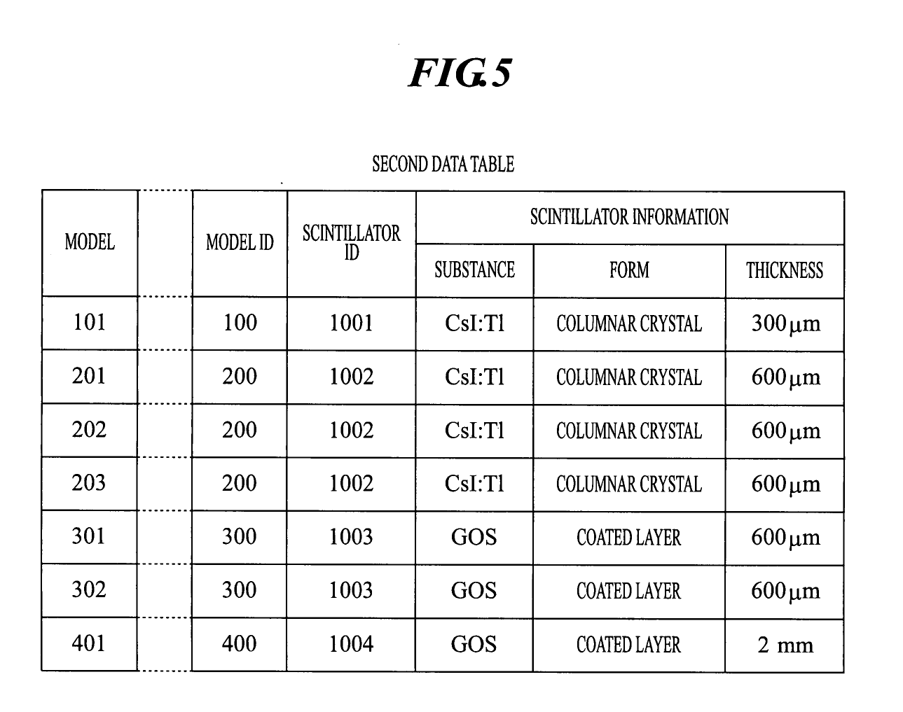

As another modification, instead of the first data table as shown in FIG. 4, a second data table as shown in FIG. 5 may be stored in advance in the memory 26.

In the second data table, a “model ID (identification)”, which is proper to a model of the radiation detector 10, has the “scintillator ID” and the “scintillator information” corresponding thereto. Accordingly, the model ID can identify the scintillator ID, and further, as described above, the scintillator ID can identify the kind of scintillator 14. The model ID is unique to a model of the radiation detector 10, and differs from model to model. The detectors 10 belonging to the same model have a same model ID and a scintillator ID corresponding thereto, and the detectors 10 belonging to different models from each other have respective different model IDs and corresponding scintillator IDs.

In this case, the controller 25 in the control device 18 reads out a model ID and the second data table from the memory 26, identifies the scintillator information based on the model ID, and, as described above, displays the identified scintillator information on the display panel 21, as well as lights the indicator 23 with a color corresponding to the identified scintillator information.

As another modification, the scintillator information in the first and second data tables may include sensitivity, use, etc. other than the substance, form and thickness. The controller 25 may display on the display panel 21 any one of these information items “substance, form, thickness, sensitivity, use”, etc., any two to four items, or five and more items.

Similarly, the controller 25 may selectively light the indicator 23 with a color corresponding to any one of these information items “substance, form, thickness, sensitivity, use”, etc., any two to four items, or five and more items.

### Second Embodiment

A radiographic imaging system 200 according to a second embodiment differs from the radiographic imaging system 1 of the first embodiment in the following point, and is identical to the first embodiment (including modifications) except the following item.

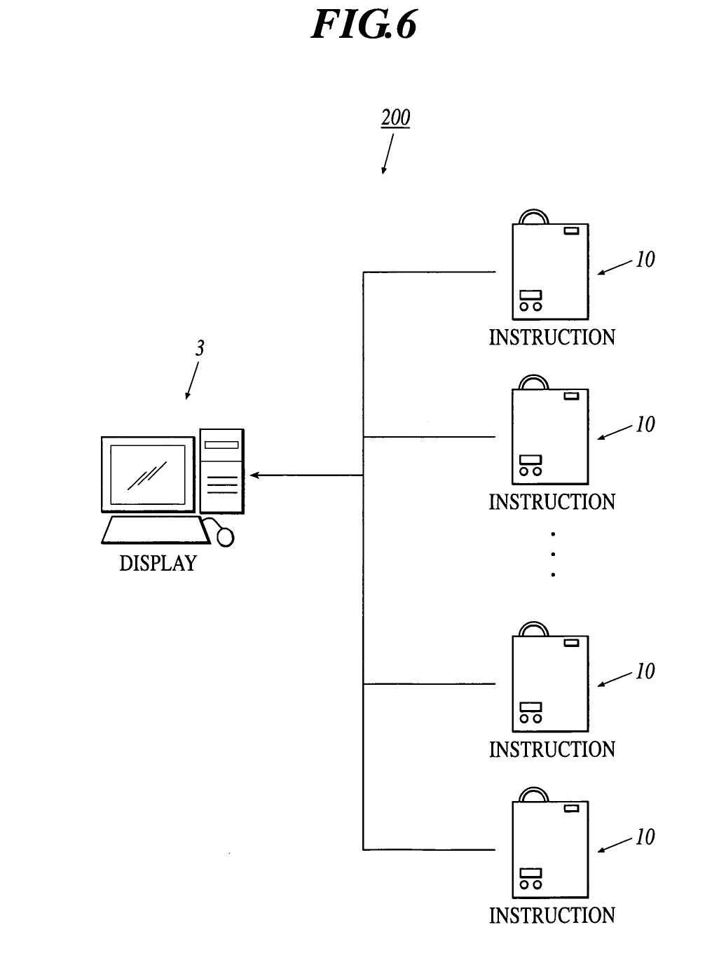

As shown in FIG. 6, in the radiographic imaging system 200, one console 3 is connected to a plurality of the radiation detectors 10. The controller 25 of each radiation detector 10 reads out a scintillator ID (or model ID) and the first data table (or second data table) from the memory 26 to identify scintillator information, then sends to the console 3 the scintillator information and a signal to display the scintillator information on the display 32 for displaying the scintillator information on the display 32. That is, each radiation detector 10 acts as an instructing source, and causes the console 3 to display the scintillator information of each radiation detector 10.

Here, in the second embodiment, scintillator information items to be displayed on the display 32 may be any one of information items “substance, form, thickness, sensitivity, use”, etc. of the scintillator 14, any two to four items, or five and more items.

### Third Embodiment

A radiographic imaging system 300 according to a third embodiment differs from the radiographic imaging system 1 of the first embodiment in the following point, and is identical to the first embodiment (including modifications) except the following item.

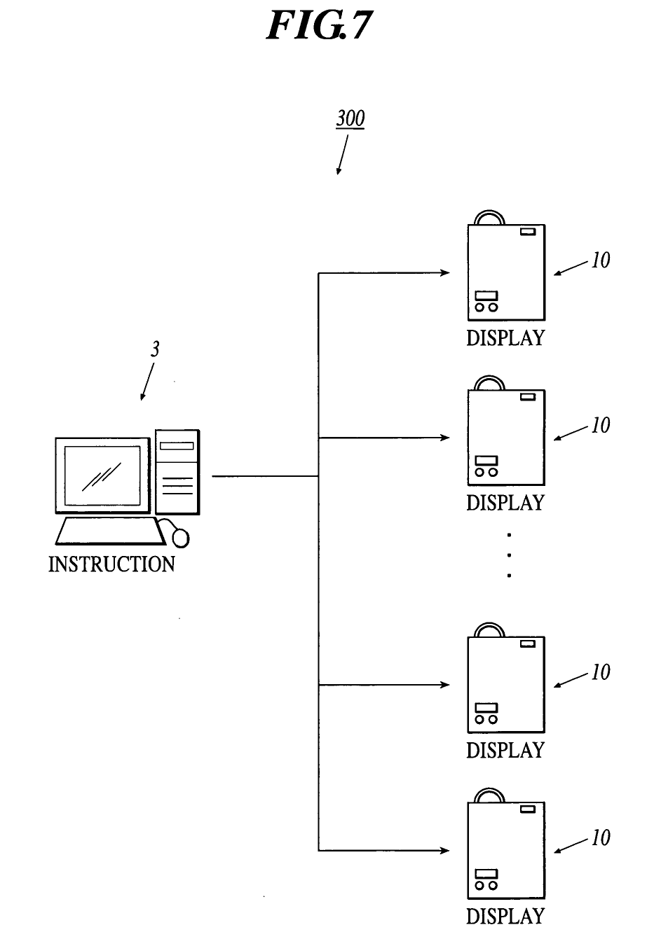

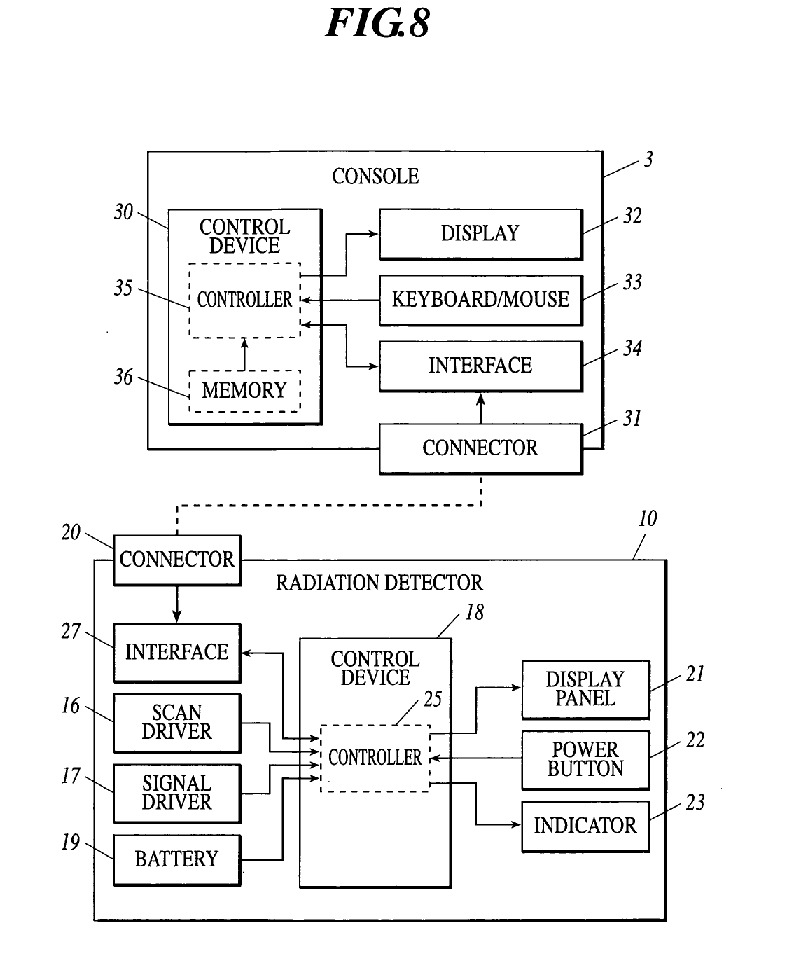

As shown in FIG. 7, in the radiographic imaging system 300, one console 3 is connected to a plurality of the radiation detectors 10, and each radiation detector 10 does not have a memory 26 in the control device 18 (see FIG. 8). As shown in FIG. 8, the control device 30 of the console 3 has a memory 36 as a console memory part, the memory including a HD (hard disk) or a ROM. The memory 36 stores in advance the first data table (see FIG. 4) or the second data table (see FIG. 5), each being the same table as that described above.

In the radiographic imaging system 300, when the operator inputs a scintillator ID or a model ID into the controller 35 of the control device 30 with operation of the keyboard/mouse 33, the controller 35 reads out the first data table or the second data table, and identifies scintillator information from the input scintillator ID or model ID. When the scintillator information is identified, the controller 35 sends the scintillator information and a control signal to the radiation detector 10 corresponding to the scintillator ID or model ID input by the operator, the control signal instructing to display the scintillator information on the display panel 21 and to light the indicator 23 with a color corresponding to the scintillator information, thus causing the display panel 21 of the detector 10 to display the scintillator information, and the indicator 23 of the detector 10 to be lit with a color corresponding to the scintillator information. That is, the console 3 acts as an instructing source, and causes each radiation detector 10 to display the scintillator information.

Here, in the third embodiment, scintillator information items to be displayed on the display panel 21 may be any one of information items “substance, form, thickness, sensitivity, use”, etc. of the scintillator 14, any two to four items, or five and more items. Similarly, the lit color of the indicator 23 corresponding to the scintillator information may be a color corresponding to any one of information items “substance, form, thickness, sensitivity, use”, etc., any two to four items, or five and more items.

The entire disclosure of Japanese Patent Application No. 2004-283710 which was filed on Sep. 29, 2004, including specification, claims, drawings and abstract, is incorporated into the present application in its entirety.

What is claimed is:

1. A radiation detector comprising:
a scintillator for generating fluorescence by receiving radiation; and
a detector indication section for indicating scintillator information relating to the scintillator.

2. The radiation detector of claim 1, further comprising:
a detector main body comprising the scintillator; and
a cassette for accommodating the detector main body,
wherein the cassette comprises the detector indication part on at least a portion of an outer surface thereof.

3. The radiation detector of claim 2, wherein the detector main body comprises the detector indication section.

4. The radiation detector of claim 1, further comprising:
a detector memory section for storing the scintillator information; and
a detector controller for causing at least a part of the scintillator information stored in the detector memory section, to be displayed on the detector indication section.

5. A radiographic imaging system comprising: a radiation detector comprising a scintillator for generating fluorescence by receiving radiation, and a console for controlling an operation of the radiation detector,
wherein the radiation detector comprises:
a detector communication section for communicating with the console; and
a detector indication section for indicating scintillator information relating to the scintillator.

6. The radiographic imaging system of claim 5, wherein the console comprises a console display section for displaying at least a part of the scintillator information.

7. The radiographic imaging system of claim 5, wherein the radiation detector further comprises:
a detector memory section for storing the scintillator information; and
a detector controller for causing at least a part of the scintillator information stored in the detector memory section, to be displayed on the detector indication section.

8. The radiographic imaging system of claim 7, wherein the console comprises:
a console communication section for communicating with the radiation detector; and
a console display section for displaying at least a part of the scintillator information, and
wherein the detector controller causes the console display section to display at least a part of the scintillator information stored in the detector memory section through the detector communication section and the console communication section.

9. The radiographic imaging system of claim 5, further comprising a plurality of the radiation detectors.

10. A radiographic imaging system comprising a radiation detector comprising a scintillator for generating fluorescence by receiving radiation, and a console for controlling an operation of the radiation detector,
wherein the radiation detector comprises:
a detector communication section for communicating with the console; and
a detector indication section for indicating scintillator information relating to the scintillator, and
wherein the console comprises:
a console communication section for communicating with the radiation detector;
a console memory section for storing the scintillator information;
a console display section for displaying at least a part of the scintillator information; and
a console controller for causing the detector indication section to display at least a part of the scintillator information stored in the console memory section through the detector communication section and the console communication section.

11. The radiographic imaging system of claim 10, further comprising a plurality of the radiation detectors.
